(19) United States
(12) Patent Application Publication
(10) Pub. No.: US 2025/0076892 A1
(43) Pub. Date: Mar. 6, 2025

(54) INFORMATION PROCESSING APPARATUS, INFORMATION PROCESSING METHOD, AND PROGRAM

(71) Applicant: Sony Group Corporation, Tokyo (JP)

(72) Inventor: Norifumi KIKKAWA, Tokyo (JP)

(73) Assignee: Sony Group Corporation, Tokyo (JP)

(21) Appl. No.: 18/723,875

(22) PCT Filed: Dec. 19, 2022
(86) PCT No.: PCT/JP2022/046603

§ 371 Date: Jun. 25, 2024

(30) Foreign Application Priority Data
Jan. 13, 2022 (JP) 2022-003950

(51) Int. Cl. G05D 1/644; G05D 1/223; G05D 1/225; G05D 101/00; G05D 107/60

(52) U.S. Cl. CPC G05D 1/644; G05D 1/223; G05D 1/225; G05D 2101/22; G05D 2107/60

(57) ABSTRACT

An information processing apparatus includes a graph structure generation unit and a path planning unit. The graph structure generation unit generates a graph where a door on a passage has been replaced by a shunting line of a virtual robot. The path planning unit plans paths of a mobile body and the virtual mobile body such that the mobile body does not conflict with the virtual mobile body at an intersection between the passage and the shunting line when passing through the passage.

### FIELD

The present invention relates to an information processing apparatus, an information processing method, and a program.

### BACKGROUND

One of important functions of autonomous mobile bodies is path planning. The path planning is to calculate, using a map of a surrounding environment, a path along which a mobile body should move to a goal position. A system for controlling operation of mobile bodies in synchronization with doors of elevators is also known.

### CITATION LIST

### Patent Literature

Patent Literature 1: JP 5469097 B2
Patent Literature 2: JP H4-032471 A
Patent Literature 3: JP H5-210414 A
Patent Literature 4: JP 2005-148960 A
Patent Literature 5: JP 2013-216408 A
Patent Literature 6: JP 2012-196731 A

### SUMMARY

### Technical Problem

In conventional systems, path planning is performed without considering when and how to open and close doors. Opening and closing of doors is performed as part of movement control of mobile bodies based on path planning. When passage intervals of mobile bodies are shorter than opening/closing time of a door, congestion occurs. In a case where a plurality of doors is controlled in conjunction with each other as in an elevator or a double door, congestion can occur on the basis of constraints such as opening/closing order of the doors. These elements are not well considered in conventional systems. There is a possibility, therefore, that entire optimization including opening and closing of doors is not sufficiently performed.

The present disclosure, therefore, proposes an information processing apparatus, an information processing method, and a program capable of performing optimal path planning in consideration of opening and closing of doors.

### Solution to Problem

According to the present disclosure, an information processing apparatus is provided that comprises: a graph structure generation unit that generates a graph where a door on a passage has been replaced by a shunting line of a virtual mobile body; and a path planning unit that plans paths of a mobile body and the virtual mobile body such that the mobile body does not conflict with the virtual mobile body at an intersection between the passage and the shunting line when passing through the passage. According to the present disclosure, an information processing method in which an information process of the information processing apparatus is executed by a computer, and a program for causing the computer to execute the information process of the information processing apparatus, are provided.

### BRIEF DESCRIPTION OF DRAWINGS

FIG. 1 is a schematic diagram of a mobile body system where pathfinding is performed.

FIG. 2 is a diagram illustrating a problem in a case where doors are introduced into a path.

FIG. 3 is a diagram illustrating another problem in the case where doors are introduced into a path.

FIG. 4 is a diagram illustrating another problem in the case where doors are introduced into a path.

FIG. 5 is a diagram illustrating an example of an assumed solving method.

FIG. 6 is a diagram illustrating another example of the assumed solving method.

FIG. 7 is a diagram illustrating a method for solving problems.

FIG. 8 is a diagram illustrating an example where a path planning method in the present disclosure is applied to a double door.

FIG. 9 is a diagram illustrating an example where the path planning method in the present disclosure is applied to an elevator.

FIG. 10 is a diagram illustrating an example of a graph used as a path map.

FIG. 11 is a diagram illustrating an example of a path plan.

FIG. 12 is a diagram illustrating another example of the path plan.

FIG. 13 is a diagram illustrating a pathfinding method that uses CBS.

FIG. 14 is a flowchart illustrating pathfinding.

FIG. 15 is a diagram illustrating an example of configuration of a transportation system.

FIG. 16 is a diagram illustrating another example of the path planning.

FIG. 17 is a diagram illustrating an example of path planning including opening and closing of a double door.

FIG. 18 is a diagram illustrating an example where path planning in the present disclosure is applied to control of an elevator.

FIG. 19 is a diagram illustrating an example where a plurality of robots is accommodated in a car of an elevator.

FIG. 20 is a diagram illustrating another example where a plurality of robots is accommodated in a car of an elevator.

FIG. 21 is a diagram illustrating an example where a plurality of elevators is installed in parallel with each other.

FIG. 22 is a diagram illustrating an example of a UI for making settings for doors.

FIG. 23 is a diagram illustrating an example where the pathfinding method in the present disclosure is applied to an automatic transportation system in a factory based on an automated guided vehicle.

FIG. 24 is a diagram illustrating an example of a hardware configuration of a server.

### DESCRIPTION OF EMBODIMENTS

Embodiments of the present disclosure will be described in detail hereinafter with reference to the drawings. In each of the following embodiments, the same parts will be given the same reference numerals, and redundant description thereof is omitted.

Note that the description will be given in the following order.
1. BACKGROUND
   [1-1. Trajectory Planning and Path Planning]
   [1-2. Problems When Doors Are Introduced into Path]
   [1-3. Method for Solving Problems]
      [1-3-1. Example of Application to Double Door]
      [1-3-2. Example of Application to Elevator]
[2. Outline of Path Planning in Present Disclosure]
   [2-1. Graph Structure]
   [2-2. Example of Path Planning]
   [2-3. Pathfinding Method]
[3. Configuration of Transportation System]
[4. Specific Examples of Path Planning]
   [4-1. Path Planning Including Opening and Closing of Double Door]
   [4-2. Application to Elevator Control]
      [4-2-1. Example Where Plurality of Robots Is Accommodated in Car of Elevator]
      [4-2-2. Example Where Plurality of Elevators Is Installed in Parallel with Each Other]
[5. User Interface]
[6. Example of Application of Pathfinding Method in Present Disclosure]
[7. Example of Hardware Configuration]
[8. Effects]

### 1. BACKGROUND

### [1-1. Trajectory Planning and Path Planning]

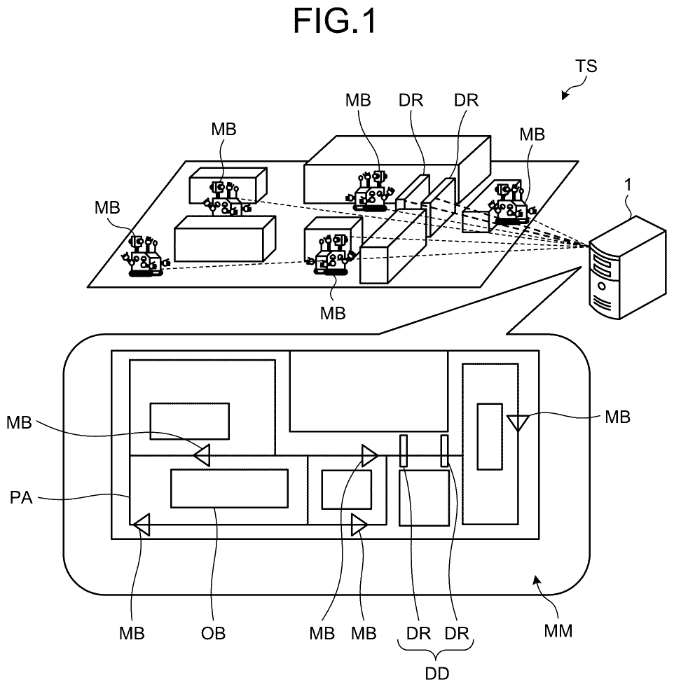

FIG. 1 is a schematic diagram of a mobile body system where pathfinding is performed. An example will be described hereinafter where mobile bodies are autonomous mobile robots MB and a mobile body system is a transportation system TS for packages or the like. In all the following drawings, the same reference numerals will be given to components of the same types. In the case of distinguishing components of the same type from each other, a number or a symbol is added after a reference numeral.

Systems that use robots MB capable of autonomously traveling are used for various purposes including, for example, transportation of articles, inspection of equipment, security, and the like. In order for a robot MB to move, it is necessary to reach a destination in such a way as not to collide with static or dynamic obstacles OB (including other robots MB) in an environment. Methods for achieving this goal are roughly divided into methods that do not use a path map and methods that use a path map.

The methods that do not use a path map are methods that use a trajectory search algorithm for directly determining a trajectory to a destination. An A* algorithm and a rapidly exploring random tree (RRT) algorithm, for example, are known as trajectory search algorithms. In these methods, recognition of an area map (movable surrounding area) of a robot MB and a trajectory search for reaching a destination based on the recognition (determination of optimum traveling speed and angular velocity at the time) are frequently repeated. As a result, collision can be avoided even when there are dynamic obstacles OB.

In the methods that do not use a path map, since a search space for determining optimum traveling speed and angular velocity is vast when an environment is large (travel distance is long or a destination is far), there is a problem that the amount of calculation is large and the frequent repetition is impossible. This method for determining a trajectory to a destination while avoiding obstacles OB by repeating surrounding environment recognition and a trajectory search will be referred to as trajectory planning.

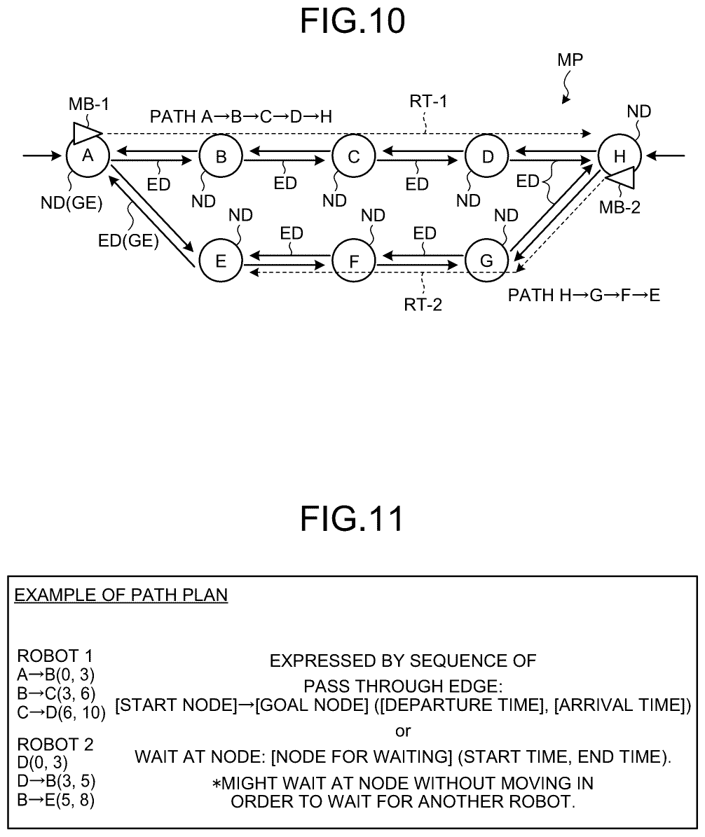

For the purpose of operating robots MB in a larger environment, there is a method that uses a path map (graph MP: refer to FIG. 10). The path map is expressed as a topological map including relay nodes as intermediate destination candidates and edges obtained by connecting relay nodes that can be directly passed through. In the methods that use a path map, path planning for determining which nodes ND and edges ED to pass through between a current position and a final destination is performed first, and a travel method between the nodes ND is then controlled on the basis of the above-described trajectory planning. As a result, the amount of calculation can be reduced compared to a case where all paths to a destination are determined on the basis of trajectory planning.

Dijkstra's algorithm or the like is often used as a path planning method. A path map is manually designed on the basis of a floor map. The floor map is provided, for example, as a metric map MM where sizes and positions of objects in a facility are accurately defined on the basis of metric data. The floor map may be obtained from a database of the facility, or may be automatically generated using simultaneous localization and mapping (SLAM) or the like. In the latter case, an area map generated by moving a robot MB in the facility can be used as the floor map.

Collision avoidance based on trajectory planning requires sufficient space to avoid collision. In a case where another robot MB approaches from ahead on a narrow road, or in a case where another robot MB suddenly enters a narrow intersection at the same time from right beside, it is not possible to calculate a trajectory for reaching a destination (a next transit node ND in the case of using a path map) in an area map that can be recognized by the robot MB. Consequently, two robots MB become stuck facing each other. This situation is called deadlock.

In the methods that use a path map, a method for resolving a situation by redoing path planning while determining a path where deadlock has occurred to be unavailable is known (path re-planning). Since a wider area can be handled in path planning than an area map that can be recognized by a robot MB, simple deadlock can be solved through path re-planning. In a case where the number of robots MB is large, however, a case where deadlock cannot be solved from a viewpoint of a single robot MB, such as a case where a robot MB faces another robot MB but cannot go back due to presence of another robot MB following behind on a road, for example, is likely to occur.

Patent Literature 1, therefore, proposes a method for performing overall optimization by performing path planning for each of robots MB using a central server instead of performing path planning using each robot MB. It is conceivable, for example, that other robots MB are caused to temporarily wait outside an intersection so that only one robot MB enters the intersection at the same time or that a traveling direction of a road is determined by time and robots MB traveling in an opposite direction are caused to temporarily wait before the road. By controlling which robot MB is caused to wait where and when, and which robot MB is caused to pass through which path and when, it becomes possible to prevent occurrence of deadlock.

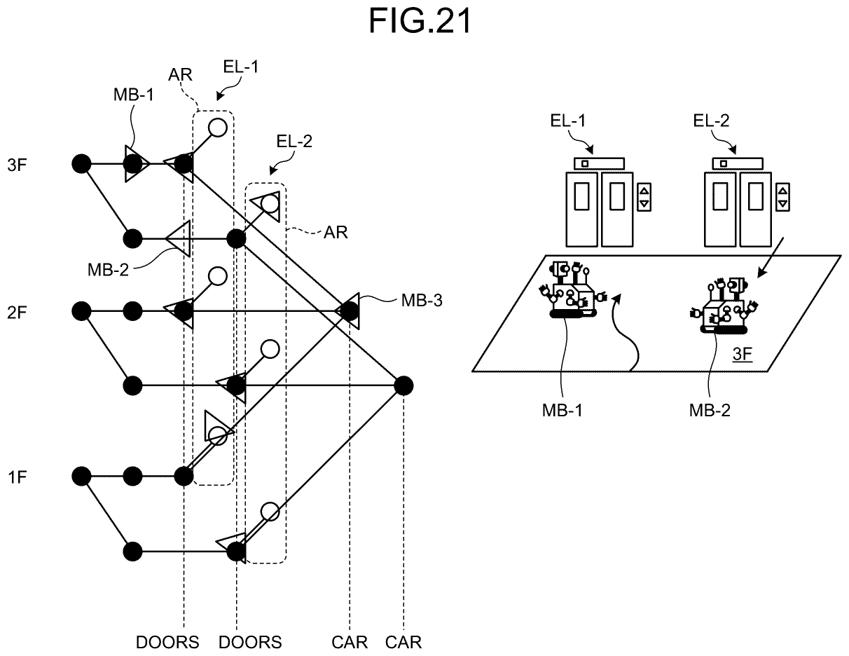

The above-described method is effective in preventing interference between operations of robots MB. In an environment where robots MB operate, equipment including double doors DD, elevators EL, and the like (refer to FIG. 21) might be installed. A method for optimizing an entire system including operation states of equipment in such a case has not been sufficiently examined so far. This problem will be described hereinafter.

[1-2. Problems When Doors Are Introduced into Path]

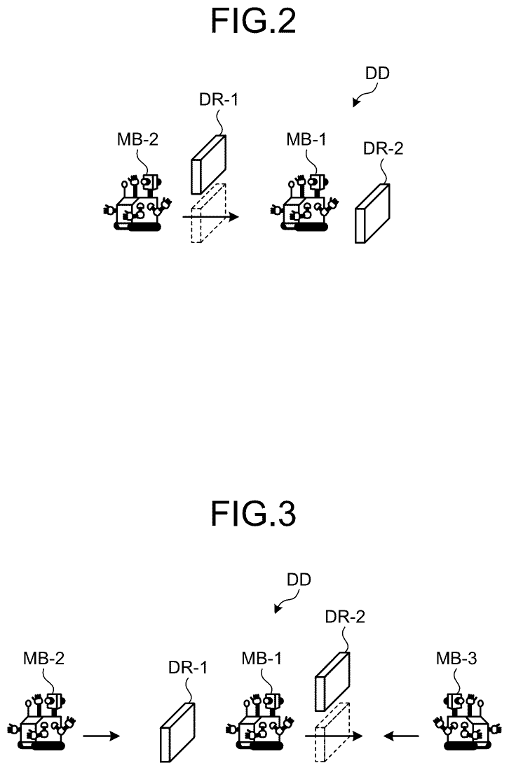

FIGS. 2 to 4 are diagrams illustrating problems in a case where doors are introduced into a path.

Patent Literatures 2 to 6 disclose systems in which the above-described multi-robot system is employed in an environment including remotely controllable elevators EL and automatic doors DR to control paths of robots MB including the elevators EL and the automatic doors DR. In any of these methods, the paths of the robots MB are temporarily planned without considering when and how to control the doors DR and the elevators EL, and as a next step, the doors DR and the elevators EL are controlled as part of movement of each robot MB according to the plan.

In Patent Literature 6, for example, which robot MB is to be moved onto an elevator EL is determined in consideration of only predetermined levels of priority. In the case of robots MB having the same level of priority, order of boarding is determined on a first come, first served basis. In addition, a robot MB that is not yet in an elevator EL standby state at a moment when an elevator EL becomes vacant is excluded as a boarding candidate. In these respects, there are limits to overall optimality.

There is a case, for example, where one door DR cannot be opened when another door DR is open like a double door DD including two front and rear doors DR as illustrated in FIG. 2. In equipment where opening and closing states of a plurality of doors DR are related to each other, how to control the facility greatly affects overall optimality of robots MB.

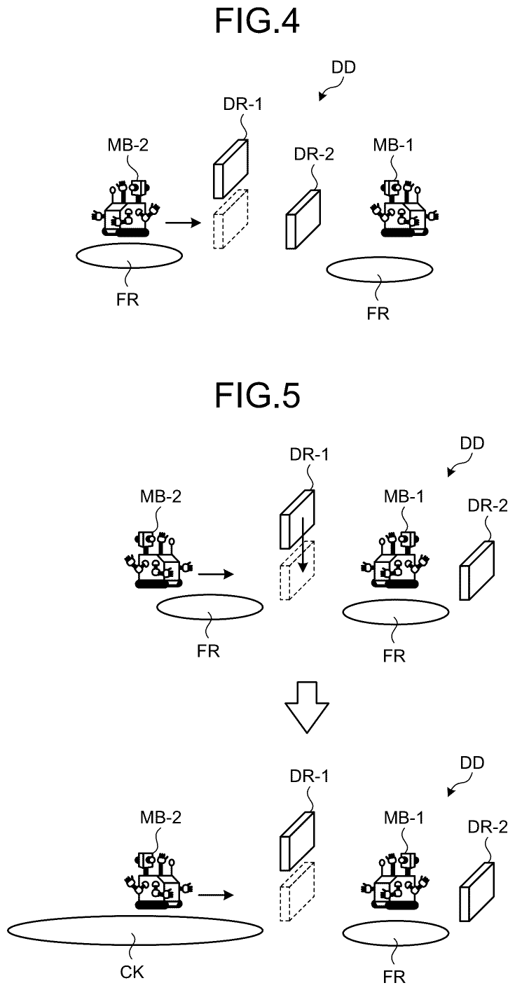

In the example of FIG. 2, for example, overall optimality is higher when two robots pass through a front door DR-2 together even if a robot MB-1 already inside a double door DD is caused to wait for a while until a robot MB-2 following behind is put in from a rear door DR-1. In an example of FIG. 3, overall optimality is higher when two robots MB-1 and MB-3 waiting in front of a front door DR are moved first than when two robots MB-1 and MB-2 pass through the front door DR-2 together after waiting for the robot MB-2 far behind. In a conventional method where order of passage is determined on a first come, first served basis, a robot MB-2, which has reached a position FR in front of a door DR first is prioritized as illustrated in FIG. 4. It is therefore difficult to achieve overall optimization in consideration of waiting states of robots MB due to opening and closing of doors DR.

Such a problem also applies to elevators EL. In the case of an elevator EL, when a door DR is opened to allow entry and exit on a certain floor, entry and exit cannot be performed on other floors. It is therefore not possible to correctly handle a case where, for example, overall optimality is higher when another robot MB coming later is put in an elevator EL first even if a certain robot MB that has already been waiting for the elevator EL is made to further wait. In a case where there is a single-lane passage in front of an elevator EL and a robot MB coming later is heading to a destination located at the dead end, for example, it is better to put the robot MB coming later in the elevator EL first. Such control, however, is not performed in a method where a robot MB that has come earlier is given priority, such as in the case of first come, first served.

In existing methods, constraints based on opening and closing of doors DR are not considered until a movement phase after path planning. In the movement phase, the above constraints are resolved by a simple equipment control standard such as first come, first served. In view of these constraints, it is basically difficult to improve overall optimality since it is not possible to solve a case where original path planning for robots MB should also be changed.

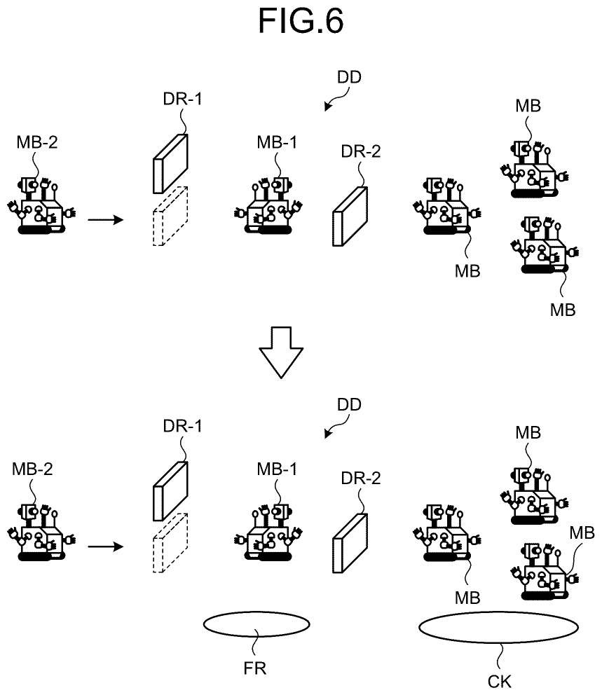

It is also conceivable to extend the equipment control standard for this problem. FIGS. 5 and 6 are diagrams illustrating examples of an assumed solving method.

FIG. 5 illustrates a scene where a robot MB-1 passing through a double door DD from left to right is closing a rear door DR-1 and opening a front door DR-2. Here, if another robot MB-2 is also passing through the same double door DD from left to right, there is a case where overall optimality is higher if the robot MB-1 waits a little while to close the rear door DR-1 and then passes through the double door DD together with the robot MB-2.

It is therefore conceivable to add a check as to whether or not there is a robot MB-2 following behind to the equipment control standard instead of simply employing first come, first served. As illustrated in a lower diagram of FIG. 5, a follower check section CK is defined in advance. If there is another robot MB-2 that is passing through the same double door DD, a robot MB waits to close a rear door DR-1, and if not, the robot MB immediately closes the rear door DR-1 and opens the front door DR-2.

FIG. 6 illustrates a similar situation but with several other robots MB waiting to pass through the double door DD in an opposite direction on an opposite side of the double door DD. In such a case, there is a case where overall optimality is higher when the plurality of opposing robots MB start to move first than when a robot MB-2 following behind is waited for. It is therefore conceivable to further adjust the equipment control standard and add a rule of immediately starting opening and closing control of the double door DD without performing a follower check when a certain number or more of robots MB are waiting beyond the door DR-2.

As described above, overall optimality can also be enhanced by assuming various situations and improving control rules of the double door DD in accordance with the assumed situations. It is not possible, however, to handle situations that have not been assumed. In addition, when a situation becomes complicated, such as a case where there is a T-junction in front of a door DR or a case where there are successive doors DR, for example, rules become complicated, and rule development cost increases. In addition, in the above case, for example, there are tuning elements such as how long the follower check section CK should be and how many opposing robots MB should exist in the case of canceling a follower check, and cost of tuning for enhancing overall optimality is also required.

### [1-3. Method for Solving Problems]

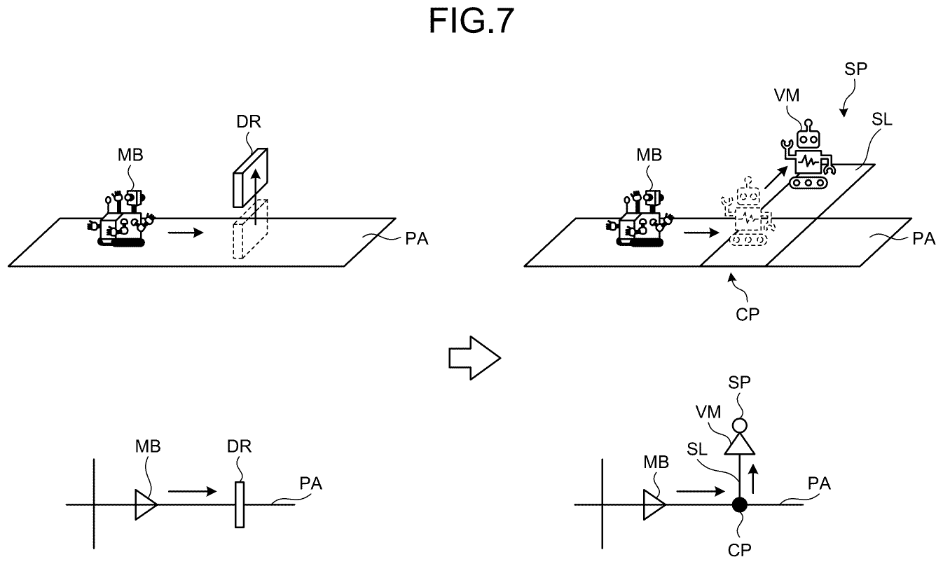

The present invention has been made in view of the above problems. In the present disclosure, the following method is employed to integrally plan operations of doors DR and robots MB. FIG. 7 is a diagram illustrating a method for solving problems.

In path planning in the present disclosure, opening and closing of a door DR is regarded as movement of a virtual robot VM on a virtual shunting line SL. For example, opening of a door DR is regarded as movement of a virtual robot from a front of the door DR (a closing position CP for blocking a passage PA of a robot MB) toward a virtual shunting position (SP). Closing of the door DR is regarded as movement of the virtual robot VM from the shunting position SP toward the closing position CP. Optimal paths of robots MB and virtual robots are planned such that the robots MB and the virtual robots do not interfere with each other. By replacing opening and closing of doors DR with movement of virtual robots VM, the opening and closing of the doors DR is planned integrally with movement of robots MB.

A point of the path planning in the present disclosure is to model behavior of doors DR and elevators EL into extension of a topological map and behavior of virtual autonomous mobile robots (virtual robots VM). As a result, opening and closing of the doors DR and the elevators EL can be planned using an existing path planning method for robots MB as is. A state where a door DR is closed or an elevator EL is located on another floor and a robot cannot move forward, for example, is modeled as a state where a virtual robot VM blocks a passage PA. A state where a door DR is open or an elevator EL is located on a destination floor and a door DR is open and a robot can move forward is modeled as a state where a passage PA is open because a virtual robot VM has moved on a shunting line SL dedicated to the virtual robot VM.

Shunting positions SP and closing positions CP are incorporated into a path map as nodes ND. Shunting lines SL are incorporated into a path map as edges ED. Opening/closing time of a door DR is regarded as a cost (movement time) at a time when a virtual robot VM moves between a shunting position SP and a closing position CP along a shunting line SL. By regarding opening/closing time of doors DR as movement costs of virtual robots VM, a pathfinding algorithm for robots MB is directly used for path planning for the virtual robots VM. Consequently, the path planning for the robots MB and the virtual robots VM is integrally performed on the basis of the same algorithm.

The virtual robots VM are allowed to move only along the shunting lines SL. The normal robots MB cannot move on the shunting lines SL. Under such constraints, a condition that the virtual robots VM can move only on shunting positions SP, closing positions CP, and the shunting lines SL and the normal robots MB cannot move on the shunting lines SL and the shunting positions SP is given when the path planning is performed. Both the virtual robots VM and the normal robots MB can move to the closing positions CP.

As a movement cost along a shunting line SL, a value based on time taken to switch passability is set. In the case of a door DR, for example, a period of time from transmission of a control signal to completion of actual opening or closing of the door DR is set as the movement cost. When the period of time (cost) is different between opening and closing, different costs are set in accordance with movement directions. When movement costs of a door DR of an elevator EL on a certain floor is set, a movement cost in an opening direction (a virtual robot VM moves to a shunting position SP along a shunting line SL) is set on the basis of average time taken for the elevator EL to move to the floor and time taken for the door DR to open. A movement cost in a closing direction (the virtual robot VM moves from the shunting position SP to a closing position CP along the shunting line SL) can be simply set as time taken for the door DR of the elevator EL to close.

The above-described method can also be applied to a case where passability control at a certain point depends on a passability state at another point, such as doors DR of an elevator EL that can be opened only on one floor at the same time or a double door DD whose doors cannot be open simultaneously.

### [1-3-1. Example of Application to Double Door]

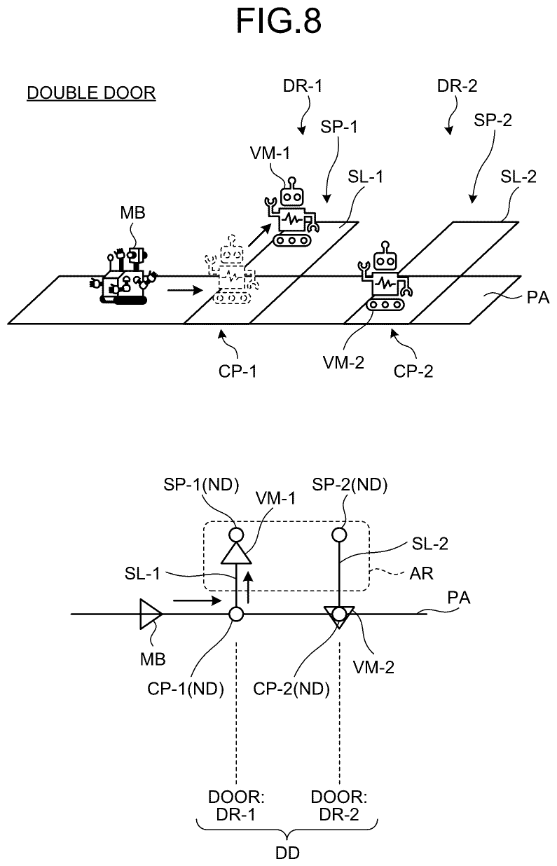

FIG. 8 is a diagram illustrating an example where the path planning method in the present disclosure is applied to a double door DD.

Here, a concept of area is used to limit the number of objects (robots MB and virtual robots VM) that can simultaneously enter a specific area. For example, a plurality of shunting lines SL representing points that cannot be open simultaneously is set as one area AR subjected to entry restriction. In the example of FIG. 8, a shunting line SL-1 and a shunting position SP-1 corresponding to a door DR-1 and a shunting line SL-2 and a shunting position SP-2 corresponding to a door DR-2 are set as one area AR. In performing path planning, there is a constraint that the total number of robots MB and virtual robots VM that can simultaneously exist in the same area AR be only one.

On the basis of a topological map modified in this manner, path planning for the plurality of robots MB including the added virtual robots VM is performed. As a result, how to move not only the real robots MB but also the virtual robots VM and how to make the robots wait are planned.

The robots MB and the doors DR are controlled on the basis of a created path plan. At this time, control of the robots MB may be the same as in the related art, but the virtual robots VM are controlled while being replaced by opening and closing control of the doors DR. For example, a start of movement of a virtual robot VM from a closing position CP to a shunting position SP is replaced by a start of opening of a door DR. A start of movement of a virtual robot VM from a shunting position SP to a closing position CP is replaced by a start of closing of a door DR.

When the path planning is performed, the control might be appropriately performed on the basis of current positions of the robots MB and a report of arrival at each of intermediate path points. In the above-described path planning method, for example, where each robot should be is defined as time-series data, but in practice, the robot might not be able to move as planned. At a time of the planning, therefore, there is also a method (order control) for establishing only an order relationship obtained from the planning (which robots should pass through which intersection in which order) instead of time-level control. In the order control, a method is employed in which where a certain robot MB currently is and whether the robot MB has passed through a key node ND along a path are checked and then waiting of another robot MB is canceled.

When the control is performed using such a method, a current position of a virtual robot VM is determined on the basis of a state of a corresponding door DR. When the door DR is open, it is determined that the virtual robot VM is at the shunting position SP. If the door DR is being closed, it is determined that the virtual robot is moving toward the closing position CP along the shunting line SL. In addition, completion of opening of the door DR is regarded as arrival of the virtual robot VM at the shunting position SP. In addition, completion of closing of the door DR is regarded as arrival of the virtual robot VM at the closing position CP.

### [1-3-2. Example of Application to Elevator]

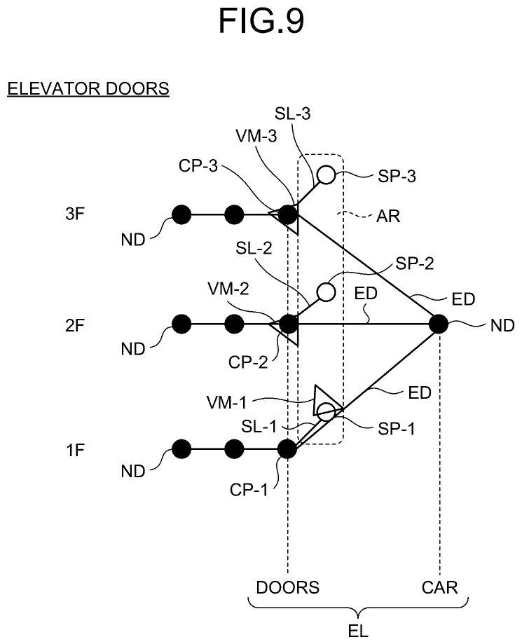

FIG. 9 is a diagram illustrating an example where the path planning method in the present disclosure is applied to an elevator EL.

The elevator EL cannot simultaneously open doors DR on a plurality of floors. When the door DR on a certain floor is open, the doors DR on all the other floors are closed. Doors on a plurality of floors belonging to the same elevator EL, therefore, are set as one area AR.

In the example of FIG. 9, an installation place of the elevator EL is from a first floor to a third floor. When a virtual robot VM-1 on the first floor is present on a shunting line SL-1 on the first floor or at a shunting position SP-1 on the first floor, a virtual robot VM-2 on the second floor and a virtual robot VM-3 on the third floor are present at a closing position CP-2 on the second floor and a closing position CP-3 on the third floor, respectively.

The area AR, therefore, is set as an area extending over the shunting line SL-1 and the shunting position SP-1 corresponding to a door DR on the first floor, a shunting line SL-2 and a shunting position SP-2 corresponding to a door DR on the second floor, and a shunting line SL-3 and a shunting position SP-3 corresponding to a door DR of the third floor. In performing path planning, there is a constraint that the total number of robots MB and virtual robots VM that can simultaneously exist in the same area AR be only one.

### [2. Outline of Path Planning in Present Disclosure]

### [2-1. Graph Structure]

FIG. 10 is a diagram illustrating an example of a graph MP used as a path map.

As described above, path planning is one of basic problems for autonomous mobile robots MB. In order to efficiently find the shortest path, the graph MP illustrated in FIG. 10 is used. The graph MP includes nodes ND and edges ED as graph elements GE. The graph MP is a topological map representing an environment where robots MB move. The graph MP is created on the basis of arrangement of obstacles OB in the environment and the like. The graph MP might be an undirected graph or a directed graph (capable of expressing one-way traffic). FIG. 10 illustrates an example of a directed graph.

### [2-2. Example of Path Planning]

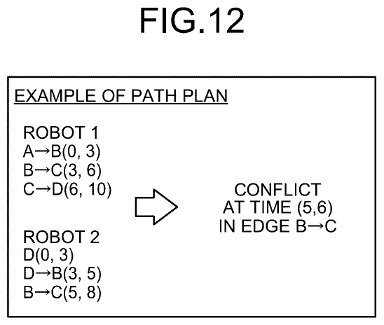

FIGS. 11 and 12 are diagrams illustrating examples of a path plan.

A path plan is represented by, for example, nodes ND and edges ED to be passed through and a series of times of passing through the nodes ND and the edges ED. When a robot passes through an edge ED, the path plan is represented by a time at which the robot departs from a node ND at one end of the edge ED and a time at which the robot arrives at another node ND. When a robot waits at a node ND, the path plan is represented by a start time and an end time of the waiting. Arrangement of passage times of edges ED and waiting times at nodes ND from a start point (node ND) to a goal point (node ND) is a path plan.

In a case where a plurality of different robots MB waits at the same node ND or passes through the same edge ED at the same time, it is considered that such paths RT are in conflict (also referred to as interference). In multi-robot path planning, a set of paths RT without conflict is required. A set of paths RT without conflict is obtained through, for example, a graph search algorithm such as A* (A-star) or conflict-based search (CBS).

In most multi-robot path planning algorithms, there is a process for checking for conflicts between paths RT. In the checking for conflicts between paths RT, whether there is an overlap between times when robots MB wait at a node ND or times when robots MB pass through an edge ED is checked for all the nodes ND and the edges ED of the graph MP. In a case where there is at least one time overlap, the set of paths RT is considered to be in conflict, and another set of paths RT is searched for.

### [2-3. Pathfinding Method]

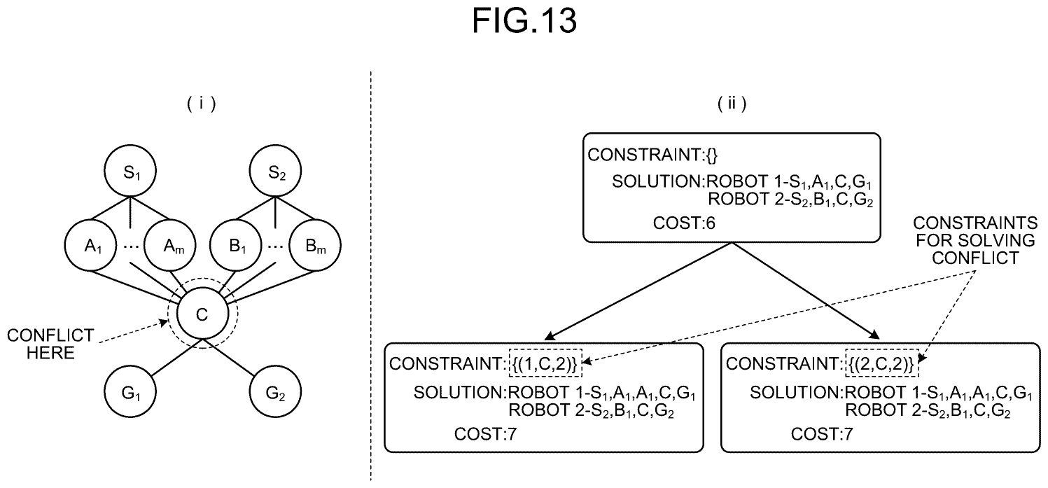

FIG. 13 is a diagram illustrating a pathfinding method that uses the CBS.

The CBS is an algorithm that starts from the shortest path of each of robots MB (not considering presence of other robots MB), that solves conflicts between the robots MB one by one, and that finally obtains an optimum solution without conflict (=a set of path plans with which all the robots MB can reach goals fastest). An optimum solution is achieved by expanding a binary tree called a constraint tree CT and searching for a solution.

A graph MP including vertexes S₁, S₂, A₁, . . . , Aₘ, B₁, . . . , Bₘ, C, G₁, and G: illustrated in a left diagram (i) will be taken as an example for consideration. The vertex S₁ and the vertex S: are nodes ND of start points of a robot MB-1 and a robot MB-2, respectively, and the vertex G₁ and the vertex G: are nodes ND of goal points of the robot MB-1 and the robot MB-2, respectively. The robots MB go one edge ED at each time step. At this time, the constraint tree CT is expanded as illustrated in a right diagram (ii).

Each node ND of the constraint tree CT includes (1) a set of constraints, (2) a set of path plans of robots MB, and (3) a total cost (cost is the number of steps required for the robots MB to reach goals).

First, a root node (an uppermost node ND of the constraint tree CT) is the shortest path of each robot MB without constraint. A path RT-1 of the robot MB-1, therefore, is S₁→A₁→C→G₁, and a path RT-2 of the robot MB-2 is S₂→B₁→C→G₂. Here, the robot MB-1 and the robot MB-2 are in conflict at the vertex C in a second step. A child node to which a constraint that the vertex C not be reached in the second step is added, therefore, is generated. At this time, two child nodes are formed as a constraint on the robot MB-1 and a constraint on the robot MB-2.

A constraint is represented by (1) a target robot MB, (2) an unreachable vertex, and (3) a corresponding step. “Con: {(1, C, 2)}” in the figure is a constraint that the robot MB-1 should not reach the vertex C in the second step. In a child node, the shortest path of each robot MB is recalculated on the basis of a constraint.

In a left child node in the figure, for example, the robot MB-1 waits for one step at the vertex A₁ (S₁→A₁→A₁→C→G₁) due to a constraint. The above-described conflict can be resolved in this way. Since the waiting adds one step, the total cost has increased by one relative to a parent node. By repeatedly performing this operation, a combination of paths RT without conflict is finally found. In addition, by developing from a node ND with the smallest total cost, a first found combination of paths RT without conflict becomes an optimal solution (=a solution with the smallest cost).

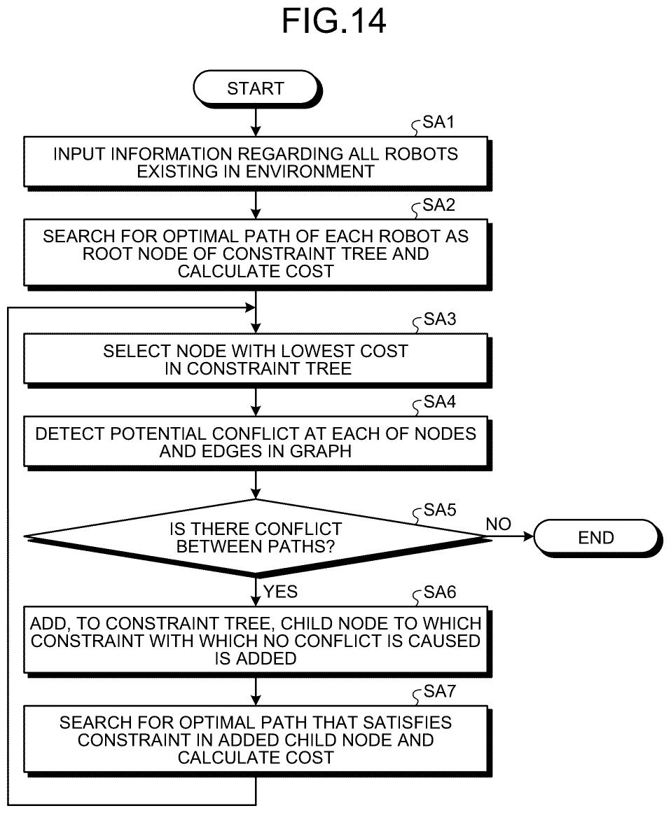

FIG. 14 is a flowchart illustrating pathfinding.

First, a user inputs information regarding all robots MB existing in an environment (step SA1). A search system searches for an optimal path of each robot MB as a root node of a constraint tree CT and calculates a cost (step SA2). The search system selects a node ND with the lowest cost in the constraint tree CT (step SA3). The search system detects a potential conflict at each of nodes ND and edges ED in a graph MP (step SA4).

The search system determines whether there is a conflict between paths of two robots MB (step SA5). If it is determined that there is a conflict (step SA5: Yes), the search system adds, to the constraint tree CT, a child node to which a constraint with which no conflict is caused is added (step SA6). The search system then searches for an optimal path that satisfies the constraint in the added child node, and calculates a cost (step SA7). The process returns to step SA3, and the above processing is repeated. If it is determined in step SA5 that there is no conflict (step SA5: No), the search system recognizes the path of each robot MB as an optimal solution, and ends the process.

### [3. Configuration of Transportation System]

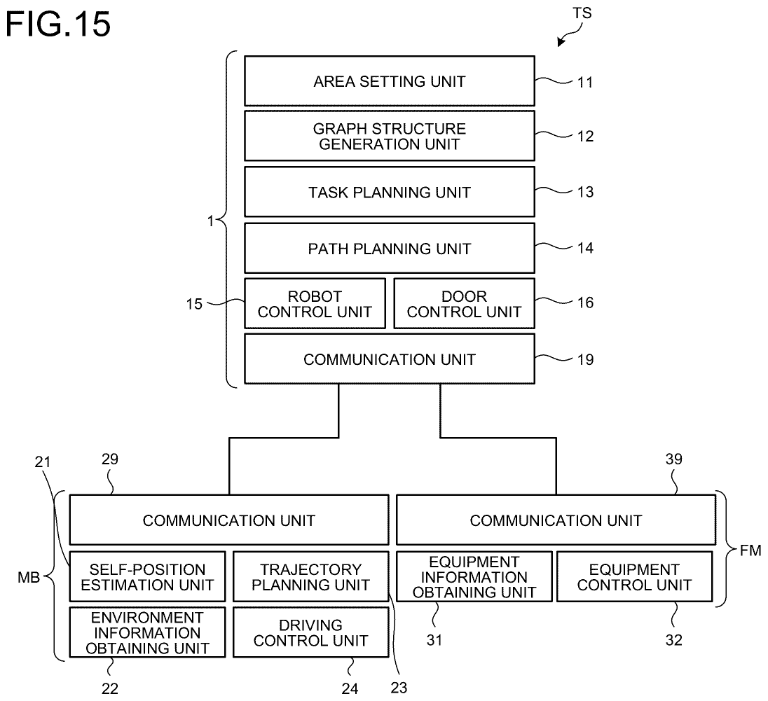

FIG. 15 is a diagram illustrating an example of configuration of the transportation system TS.

The transportation system TS transports objects to be transported using autonomous mobile robots MB provided for a facility such as a distribution center. The transportation system TS is a type of mobile body system that causes mobile bodies to perform certain processing. The transportation system TS includes a server 1, a robot MB, and an equipment management apparatus FM. The equipment management apparatus FM manages various pieces of equipment installed in the facility. The equipment in the facility includes doors DR, elevators EL, and the like. The robot MB and the equipment management apparatus FM are connected to the server 1 over a network. The transportation is performed by controlling the robots MB and the equipment management apparatus FM in accordance with transportation instructions input to the server 1.

A system intended for transportation will be described in the present disclosure, but the path planning method in the present disclosure can also be applied to a system not intended for transportation. Examples of the system not intended for transportation include a monitoring system that regularly patrols a target area, a system that guides guests who come to a store with robots MB, and an automatic parking lot for self-driving cars.

### <Robot>

A robot MB is, for example, a trackless autonomous mobile robot that does not use a traveling rail. When a target point is given through a communication unit 29, the robot MB autonomously plans a trajectory and moves to the target point. The robot MB incorporates sensors such as a camera, a global positioning system (GPS), a light detection and ranging or a laser imaging detection and ranging (LiDAR), and an inertial measurement unit (IMU).

The robot MB includes a self-position estimation unit 21, an environment information obtaining unit 22, a trajectory planning unit 23, a driving control unit, and the communication unit 29. The environment information obtaining unit 22 obtains information (environment information) regarding an external environment of the robot MB on the basis of sensor data from the built-in sensors. The self-position estimation unit 21 generates an area map and estimates a self-position (a position of the robot MB) on the basis of the environment information using a technique such as SLAM.

The environment information and information regarding the self-position information are supplied to the server 1 through communication units 19 and 29. The server 1 extracts information regarding passability of passages PA from the environment information. The server 1 performs path planning on the basis of information regarding the self-position of each robot MB and the information regarding passability of the passages PA. Information regarding the path planning is supplied to each robot MB through the communication units 19 and 29.

The trajectory planning unit 23 detects obstacles OB ahead on the basis of the environment information. The trajectory planning unit 23 plans a desirable trajectory for moving to a target point (next node ND) while avoiding the obstacles OB. The trajectory planning refers to a certain level of control where a margin (mm) with which the robot MB should pass by a nearby obstacle OB and what kind of curve the robot MB should draw when passing through a corner to move safely and smoothly are determined.

A driving control unit 24 controls driving of the robot MB on the basis of a path plan generated using positional information regarding each robot MB and a trajectory plan determined on the basis of the information regarding the obstacles OB and the like. The driving control also includes control relating to a process for transferring objects to be transported and the like. By frequently repeating the trajectory planning and the driving control, the robot MB can move safely even if there are moving obstacles OB and the like.

Although trackless autonomous mobile robots are used as the robots MB in the example of FIG. 15, the robots MB are not limited to this. The path planning method in the present disclosure is applicable to any robot MB whose movement can be controlled through communication. For example, the method in the present disclosure can also be applied to tracked autonomous mobile robots that use traveling rails and robots MB of a type whose driving is directly controlled from a remote location, such as so-called radio-controlled robots.

### <Equipment Management Apparatus>

The equipment management apparatus FM controls opening and closing of one or more doors DR installed in the facility. The doors DR are automatic doors whose opening and closing can be controlled on the basis of opening/closing instructions given through a communication unit 39. In addition to the doors DR, monitoring sensors that monitor the periphery of the doors DR are installed in the facility. As the monitoring sensors, infrared sensors or the like are used. When an elevator EL is installed in the facility, the equipment management apparatus FM also controls opening and closing of a door DR on each of floors and raising and lowering of a car.

The equipment management apparatus FM includes an equipment information obtaining unit 31, an equipment control unit 32, and the communication unit 39. The equipment information obtaining unit 31 obtains information (monitoring information) regarding open/close states of the doors DR, states of approach of the robots MB to the doors DR, and the like on the basis of sensor data from the monitoring sensors. The server 1 performs path planning on the basis of the monitoring information obtained through the communication units 19 and 39. The equipment control unit 32 opens and closes the doors DR on the basis of a path plan generated by the server 1. In the case of an elevator EL, the equipment control unit 32 also raises and lowers the car on the basis of the path plan.

### <Server>

The server 1 is an information processing apparatus that processes various types of information for performing path planning. The server 1 controls the robots MB and the equipment management apparatus FM on the basis of transportation instructions from the outside. The server 1 includes an area setting unit 11, a graph structure generation unit 12, a task planning unit 13, a path planning unit 14, a robot control unit 15, a door control unit 16, and the communication unit 19.

The area setting unit 11 presents a user interface (UI) for visually making settings for the doors DR. Information regarding the number and arrangement of graph elements GE is supplied from the graph structure generation unit 12. The area setting unit 11 sets areas AR on the basis of user input information input through the UI.

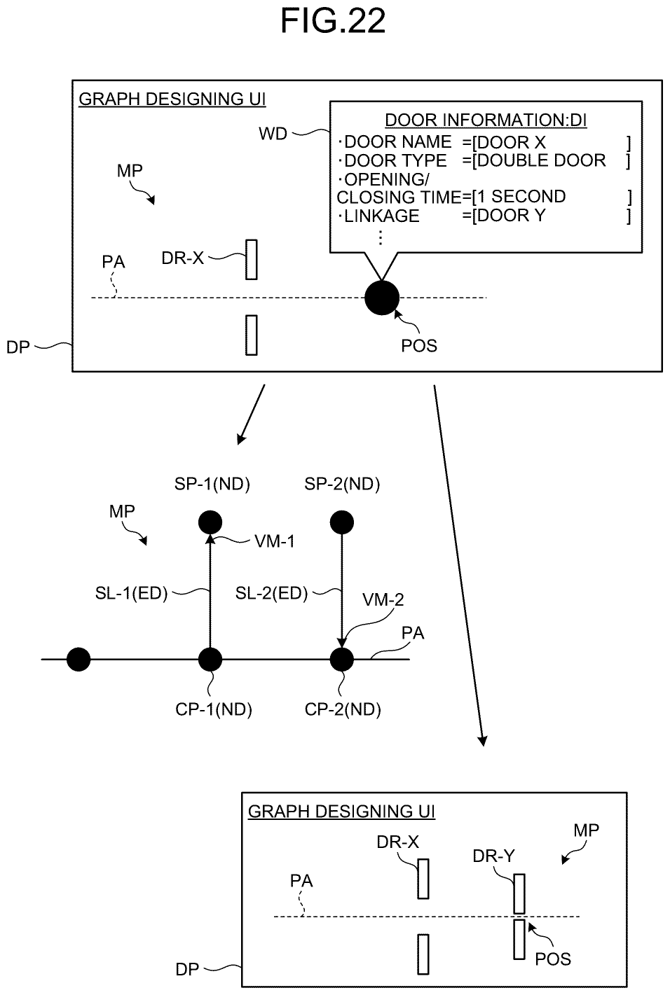

For example, the area setting unit 11 displays a UI for making settings for the doors DR on a display DP (refer to FIG. 22). The user inputs information regarding the doors DR and information regarding the areas AR using the UI. The area setting unit 11 obtains the information regarding the area AR input through the UI as user input information.

The graph structure generation unit 12 generates a graph MP where doors on passages PA are replaced by shunting lines SL of virtual robots VM on the basis of the user input information. For example, the graph structure generation unit 12 incorporates the virtual robots VM, the shunting lines SL, shunting positions SP, and closing positions CP into the graph MP on the basis of the information regarding the doors DR input through the UI. The graph structure generation unit 12 sets the areas AR in the graph MP on the basis of the user input information. Each area AR includes a plurality of graph elements GE (an edge ED and a node ND indicating a shunting line SL and a shunting position SP).

Capacity is set for each of the areas AR and the graph elements GE. The capacity indicates the total number of robots MB and virtual robots VM allowed to exist at the same time. The graph structure generation unit 12 sets the capacity of each area AR on the basis of the user input information. The graph structure generation unit 12 sets the capacity of all the graph elements GE included in the graph MP to, for example, 1. The graph structure generation unit 12 generates a graph MP that reflects information regarding the areas AR and the capacity, and supplies the graph MP to the path planning unit 14.

The task planning unit 13 assigns the most appropriate robot MB as a transportation subject in view of content of a transportation instruction. The task planning unit 13 divides work to be done by the robot MB that serves as the transportation subject, and generates a task plan for causing the robot MB to sequentially perform a plurality of tasks obtained as a result of the division. The task planning unit 13 supplies the generated task plan to the driving control unit 24 of the robot MB that serves as the transportation subject.

In the case of a transportation instruction of “transport an object X to be transported from a point A to a point B”, for example, the task planning unit 13 divides a task indicated by the transportation instruction into a task of moving to the point A, a task of loading the object X at the point A, a task of moving to the point B, and a task of unloading the object X at the point B. The task planning unit 13 generates a task plan for causing the robot MB that serves as the transportation subject to sequentially perform the plurality of tasks obtained as a result of the division.

Various methods can be considered as methods for determining a robot MB to serve as a transportation subject. In a case where all the robots MB are available robots MB with no tasks, for example, an available robot MB closest to a destination of a task of moving to the destination may be determined as a transportation subject. In a case where there is no available robot MB, a robot MB with the smallest number of assigned tasks may be determined as a transportation subject.

The path planning unit 14 determines which path RT each robot MB should follow to move to a destination. Here, the path planning refers to a certain level of planning where which robots MB should pass through which passage PA in which order is determined in consideration of one-lane passages and the like on which robots MB cannot pass each other.

For example, the path planning unit 14 obtains information regarding areas AR and capacity from the graph MP. The path planning unit 14 plans a path RT of each of the robots MB and the virtual robots VM in the graph MP such that that no conflict occurs between a robot MB and a virtual robot VM exceeding the capacity of an area AR in the area AR. The determination as to conflict is made not only for a conflict between robots MB but also for a conflict between a robot MB and a virtual robot VM and a conflict between virtual robots VM. The path planning unit 14 plans paths RT of a robot MB and a virtual robot VM such that the robot MB does not conflict with the virtual robot VM at an intersection between a passage PA and a shunting line SL when passing through the passage PA.

For example, the path planning unit 14 first obtains the shortest paths of each robot MB and each virtual robot VM without considering conflicts in the areas AR, the nodes ND, and the edges ED. The search for the shortest paths is performed using a known method such as A*. In a case where a conflict occurs in any of the areas AR, the nodes ND, and the edges ED in the calculated shortest paths of each robot MB and each virtual robot VM, the path planning unit 14 obtains the shortest paths of the robot MB and the virtual robot VM again with a part where the conflict has occurred as a constraint. By repeating this, the path planning unit 14 searches for a set of paths RT of each robot MB and each virtual robot VM with which no conflict occurs.

The path planning unit 14 generates path information regarding each robot MB and each virtual robot VM on the basis of finally obtained paths RT of the robot MB and the virtual robot VM. The path information includes information regarding destinations and movement times (movement timing) of the robot MB and the virtual robot VM. The path planning unit 14 supplies the path information regarding each robot MB and each virtual robot VM to the robot control unit 15 and the equipment control unit 32.

In a case where there is a robot MB to which a new destination has been added, the path planning unit 14 may perform additional path planning only for the robot MB to which the new destination has been added without changing path plans of other robots MB, or may perform overall optimization including a review of the path plans of the other robots MB.

The robot control unit 15 generates a movement instruction for each robot MB on the basis of the path information regarding the robot MB. The movement instruction includes information regarding a destination and movement times (movement timing) of the robot MB. The movement instruction may be generated as a string of data regarding which graph elements GE the robot MB passes through in which order. The robot control unit 15 transmits the movement instruction for each robot MB to the robot MB through the communication unit 19.

The door control unit 16 generates opening/closing instructions for a corresponding door DR on the basis of path information regarding a virtual robot VM. Each opening/closing instruction includes information regarding a direction of a state change of the door DR (an opening direction or a closing direction) and a start time of the state change (start timing of opening or closing). The door control unit 16 replaces movement of a virtual robot VM from a closing position CP to a shunting position SP with opening of a door DR and movement of the virtual robot VM from the shunting position SP to the closing position CP with closing of the door DR to generate opening/closing instructions.

The door control unit 16 transmits opening/closing instructions for each door DR to a corresponding equipment control unit 32 through the communication unit 19. In a case where a door DR is a door of an elevator EL, the door control unit 16 also generates instructions to raise or lower a car of the elevator EL in accordance with opening and closing of the door DR. In a case where a virtual robot VM on a first floor completes movement from a shunting position SP to a closing position CP and then a virtual robot VM on a second floor starts to move from a closing position CP to a shunting position SP, for example, the door control unit 16 generates an operation for causing the car to move from the first floor to the second floor as a raising/lowering instruction when the virtual robot VM on the first floor has completed the movement to the closing position CP. The door control unit 16 transmits raising/lowering instructions to the equipment control unit 32 together with opening/closing instructions.

The graph structure generation unit 12 sets, as one area AR, a plurality of doors DR whose opening and closing depends on each other so that only one of the doors DR is in an open state at a time. The path planning unit 14 plans paths RT of a plurality of virtual robots VM corresponding to the plurality of doors DR such that the plurality of virtual robots MB does not conflict in the same area AR.

For example, a plurality of doors DR whose opening and closing depends on each other can include a pair of doors DR constituting a double door DD. In a case where the double door DD exists in a passage PA, the path planning unit 14 calculates a cost of a path plan of one or more robots MB to be optimized on the basis of the number of steps until each robot MB reaches a goal and time taken to open or close each door DR existing in the graph MP.

The plurality of doors DR whose opening and closing depends on each other can include doors DR of an elevator EL installed on different floors. In a case where the elevator EL exists in a passage PA, the path planning unit 14 calculates a cost of a path plan of one or more robots MB to be optimized on the basis of the number of steps until each robot MB reaches a goal, time taken to open or close each door DR existing in the graph MP, and time taken for a car of the elevator EL to reach a position of a door DR that is to be in an open state.

### [4. Specific Examples of Path Planning]

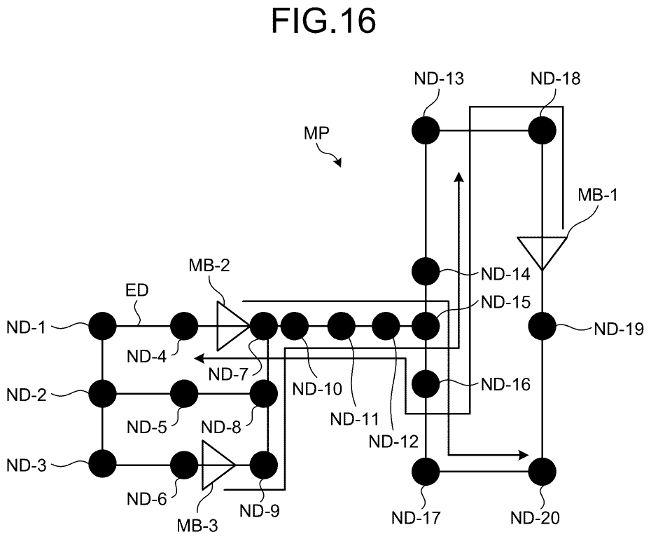

Specific examples of the path planning will be described hereinafter. FIG. 16 is a diagram illustrating another example of the path planning.

Nodes ND are provided at transportation destination points, points where edges ED intersect, points where waiting can be performed, such as in front of intersections, and the like. FIG. 16 illustrates an example of a graph MP including nodes ND-1 to ND-20 and edge ED connecting the nodes ND. A cost of movement according to movement time is defined for each edge ED. In path planning that uses a graph MP, a combination of paths of robots MB that does not cause interference between the robots MB is calculated. A total cost of reaching a destination including waiting time is calculated for each robot MB, and a combination of paths of the robots MB with which the sum of the total costs of all the robots MB is the smallest is determined as an optimal solution.

As a specific process, first, a graph MP (hereinafter referred to as a unit graph) where movement costs of all edges ED are uniform is generated by diving of the edges ED. In the example of FIG. 16, for example, a movement cost of an edge ED between the node ND-7 and the node ND-10 is the minimum. The graph structure generation unit 12, therefore, sets the minimum movement cost as a unit cost, and adds one or more nodes ND in the middle of an edge ED with a movement cost twice or three times higher than the unit cost to divide the edge ED into two or three.

The path planning unit 14 duplicates the unit graph by the number of steps in time series. One unit graph represents a state of arrangement of robots MB and virtual robots VM at a certain time in the future. One step period is set as time according to the unit cost. A robot MB can move to an adjacent node ND by continuing to move for one step period.

The path planning unit 14 arranges the plurality of duplicated unit graphs in chronological order and performs the following process on two adjacent unit graphs. First, in a case where a position of a robot MB has not changed between the two unit graphs (a case where the robot MB waits at the same node ND for one step period), the path planning unit 14 connects nodes ND indicating the position of the robot MB in the unit graphs with a connecting line.

In a case where a position of a robot MB has changed between the two unit graphs (a case where the robot MB has moved to an adjacent node ND in one step period), the path planning unit 14 connects a node ND where the robot MB exists in the original unit graph and a node ND where the robot MB exists in the unit graph after one step period with a connecting line.

After performing the above-described process, the path planning unit 14 deletes all the edges ED in the original unit graph. Consequently, only the newly added connecting lines remain. The path planning unit 14 thus generates a time-series topological map where unit graphs at different times are combined together.

In the time-series topological map, a robot MB always moves to a node ND somewhere in a unit graph at a next time in one step. A path of a robot MB is grasped by following connecting lines along a time axis. A path plan of one robot MB is expressed as data regarding coordinates of nodes ND arranged in time-series along connecting lines. A path of the robot MB is grasped by tracing the coordinates of the nodes ND in chronological order.

When a path plan of a new robot MB is added, the simplest method is to “exclude nodes ND already occupied by path plans of other robots MB (cannot move to a node ND with another robot MB at the time)” and then select a path RT that satisfies a constraint that “the robot MB should always move to a node ND somewhere in a unit graph at a next time in one step”. This can be achieved by exclusively using only paths RT that satisfy the above constraint as search targets when searching for a path with an ordinary well-known Dijkstra's algorithm.

As another method for adding a path plan of a new robot MB, a method for collectively redoing path planning for all the robots MB is also conceivable. For example, the path planning unit 14 selects, by global search or the like, path plans that satisfy constraints of “a robot MB should always move to a node ND somewhere in a unit graph at a next time in one step”, “two or more robots MB must always not exist on any node ND in a time-series topological map”, and “two or more robots MB must always not face each other on a connecting line in a time-series topological map”. This type of search method is described in [Literature 1] below.

[Literature 1] Optimal Multi-Robot Path Planning on Graphs: Complete Algorithms and Effective Heuristics, Jingjin Yu Steven M. LaValle, 2015

The resultant path plan on the time-series topological map indicates which node ND each robot MB should be present on at which time, including waiting and the like.

### [4-1. Path Planning Including Opening and Closing of Double Door]

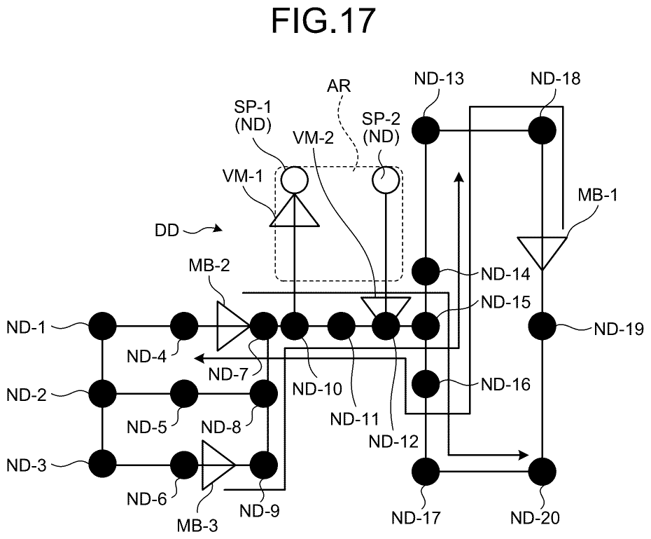

The above-described pathfinding method can also be applied to a system including virtual robots VM. FIG. 17 is a diagram illustrating an example of path planning including opening and closing of a double door DD.

A system including doors DR has constraints that “virtual robots VM can move only on closing positions CP, shunting lines SL, and shunting positions SP” and “robots MB cannot enter the shunting lines SL and the shunting positions SP”. An area AR extending over a plurality of graph elements GE, therefore, is set on the basis of the above constraints, and a new constraint that “a conflict between robots MB and virtual robots VM exceeding capacity of the area AR (one robot in the case of an elevator EL) is not permitted” is imposed on the area AR. By modifying and applying the pathfinding method in FIG. 16 in such a way as to satisfy these constraints, optimum operations of the robots MB and the doors DR can be integrally calculated.

A system including a double door DD also has a constraint that “two doors DR constituting the double door DD cannot be open simultaneously”. This constraint can be rephrased as a constraint that “only one virtual robot VM can exist at one time in an area AR” when one area AR is set for shunting lines SL and shunting positions SP corresponding to the doors DR. By newly adding such a constraint and applying the above-described pathfinding method, optimum operations of the robots MB and the double door DD can be integrally calculated.

In a case where an instruction to move a robot MB-3 to a node ND-13 is input under the above constraints while robots MB-1 and MB-2 are moving toward nodes ND-4 and ND-20, the following path planning, for example, is performed on the robots MB-1, MB-2, and MB-3 and virtual robots VM-1 and VM-2. Note that paths RT are indicated by sequences of waypoint coordinates (numbers of nodes ND) in time series. Parentheses ([ ]) described in the sequences mean pausing at that node until a condition in the parentheses is satisfied.
A path RT of the robot MB-1:
18→13→14 [MB-2: departs from 15]→15→16 [MB-3: departs from 15]→15 [VM-2: arrives at SP-2]→12→11 [VM-1: arrives at SP-1]→7→4
   A path RT of the robot MB-2:7
7 [VM-1: arrives at SP-1]→10→11 [VM-2: arrives at SP-2]→15→16→17→20
   A path RT of the robot MB-3:
9→8 [MB-2: departs from 7]-7 [VM-1: arrives at SP-1]→10→11 [VM-2: arrives at SP-2 and MB-1: departs from 15]→12→15→14→13
   A path RT of the virtual robot VM-1:
10 [VM-2: arrives at 12]→SP-1 [MB-2: departs from 10]→10 [VM-2: arrives at 12]→SP-1 [MB-3: departs from 10]→10 [MB-1: arrives at 15 and VM-2: arrives at 12]→SP-1 [MB-1: departs from 10]→10
   A path RT of the virtual robot VM-2:
12 [MB-2: arrives at 11 and VM-1: arrives at 10]→SP-2 [MB-2: departs from 12]→12 [MB-3: arrives at 11 and VM-1: arrives at 10]→SP-2 [MB-3: departs from 12 and MB-1: departs from 12]→12

### [4-2. Application to Elevator Control]

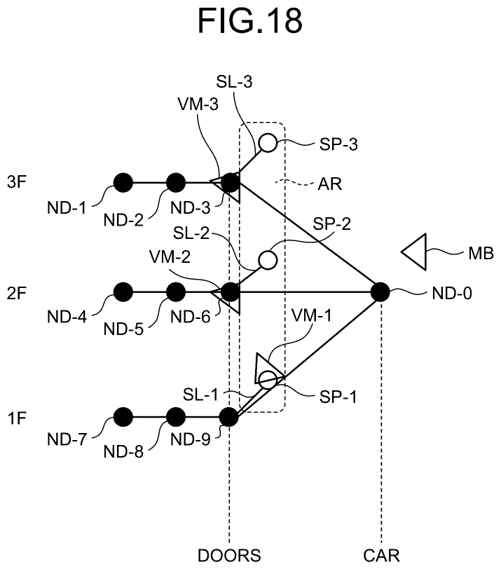

FIG. 18 is a diagram illustrating an example where path planning in the present disclosure is applied to control of an elevator EL.

A system including an elevator EL has a constraint that “doors DR on a plurality of floors cannot be open simultaneously”. This constraint can be rephrased as a constraint that “only one virtual robot VM can exist at one time in an area AR” when one area AR is set for shunting lines SL and shunting positions SP corresponding to the doors DR on the different floors. By newly adding such a constraint, optimum operations of the robots MB and the elevator EL can be integrally calculated.

In a case where an instruction to close the door DR of the elevator EL on a first floor, move a car carrying a robot MB to a third floor, open the door DR on the third floor, and move the robot MB to a node ND-1 is input under the above constraint, for example, the following path planning, for example, is performed for the robot MB and virtual robots VM-1 and VM-3.
A path RT of the robot MB:
0 [car: arrives at the third floor and VM-3: arrives at SP-3]→3→2→1
   A path RT of the virtual robot VM-1:
SP-1 [MB: arrives at 0]→9
   A path RT of the virtual robot VM-3:
3 [car: arrives at the third floor]→SP-3

### [4-2-1. Example Where Plurality of Robots Is Accommodated in Car of Elevator]

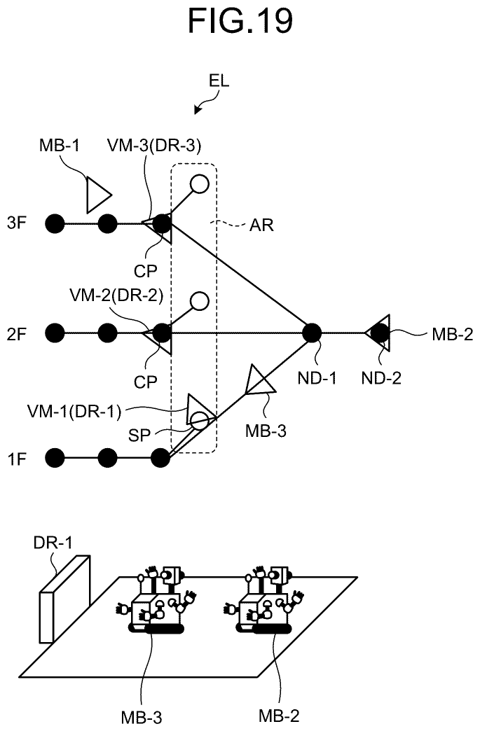

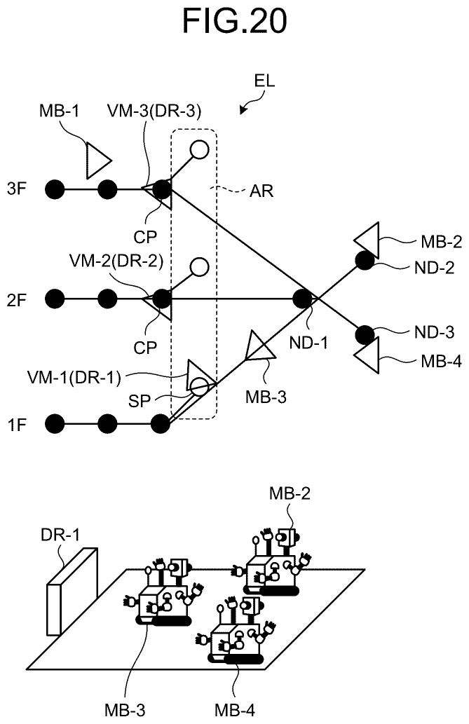

FIGS. 19 and 20 are diagrams illustrating examples where a plurality of robots MB is accommodated in a car of an elevator EL.

In the example of FIG. 19, two robots MB can be accommodated in the car. A robot MB-2 that has entered the car first moves to a node ND-2 at a back of the car to leave a node ND-1 on an entrance side of the car available. A robot MB-3 that enters the car later is accommodated at the node ND-1 on the entrance side of the car. When the robots MB-2 and MB-3 leave the car, the robot MB-3 closer to an exit side leaves first. By reflecting positions in the car in the graph MP, path planning including order in which the plurality of robots MB should enter the car and positions at which the plurality of robots MB should stay can be performed.

In the example of FIG. 20, three robots MB can be accommodated in the car. Robots MB-2 and MB-4 that have entered the car first move to nodes ND-2 and ND-3, respectively, at a back of the car to leave a node ND-1 on an entrance side of the car available. A robot MB-3 that enters the car later is accommodated at the node ND-1 on the entrance side of the car. The two nodes ND-2 and ND-3 at the back of the car are in a parallel relationship, and a robot MB that enters the car first may move to either node ND.

[4-2-2. Example Where Plurality of Elevators Is Installed in Parallel with Each Other]

FIG. 21 is a diagram illustrating an example where a plurality of elevators EL is installed in parallel with each other.

In the example of FIG. 21, two elevators EL-1 and EL-2 are operating on the same floor. Robots MB-1 and MB-2 may use either elevator EL.

A cost of traveling to a destination varies depending on which elevator EL is used. In a case where another robot MB is using an elevator, a robot MB needs to wait for the other robot, which accordingly increases the cost. In the example of FIG. 21, for example, another robot MB-3 takes the elevator EL-1 on a first floor, and waiting time varies depending on which floor the robot MB-3 gets off. No other robots MB are in the elevator EL-2, and a car is on a third floor. If the elevator EL-2 is not scheduled to be used by another robot MB, the cost of reaching a destination is reduced by using the elevator EL-2.

In the present disclosure, opening and closing of doors DR of elevators EL and raising and lowering of cars are replaced by movement of virtual robots VM, and conflicts with robots MB are determined. The waiting with the other robot MB is appropriately processed on the basis of the arrangement of the virtual robot VM (at which floor the virtual robot VM is stopped), the movement time (including the opening/closing time of the door DR and the lifting/lowering time of the basket), and the like. It is therefore possible to plan optimal paths including selection of an elevator EL based on states of use of the elevators EL-1 and EL-2 by other robots MB.

### 5. User Interface

FIG. 22 is a diagram illustrating an example of a UI for making settings for doors DR.

In a case where doors DR are set, a UI with which a plurality of nodes ND and edges ED can be visually selected is effective. The area setting unit 11 displays a graph MP on the display DP so that graph elements GE such as nodes ND and edges ED can be added. In addition, the area setting unit 11 enables a plurality of graph elements GE set as an area AR to be collectively selected through an operation performed on the UI. After the graph elements GE to be subjected to area setting are selected, capacity of the area AR can be set in a pop-up window or the like.

In a case where a door DR is added to the graph MP, for example, the user selects a position POS where the door DR is to be installed in the graph MP through an operation such as clicking. The area setting unit 11 displays a window WD for setting information (door information) regarding the door DR at the selected position POS. The door information includes, for example, information such as a name, a type, and opening/closing time of the door DR and presence or absence of another door DR that operates in conjunction with the door DR. In a case where time taken for opening and time taken for closing are different from each other, an input field for separately inputting the times may be provided.

When the inputting of the door information is completed, the graph structure generation unit 12 adds a new node ND to the selected position POS and sets the added node ND as a closing position CP of the door DR. The graph structure generation unit 12 adds a shunting position SP, a shunting line SL, and a virtual robot VM to the graph MP together with the closing position CP. The graph structure generation unit 12 makes settings for limiting a movable range of the virtual robot VM to the shunting position SP, the shunting line SL, and the closing position CP and excluding the shunting position SP and the shunting line SL from a movable range of the robot MB.

The area setting unit 11 displays, on the UI, the graph MP to which the closing position CP, the shunting position SP, and the shunting line SL have been added. The user sets the area AR in the displayed graph MP. For example, the area setting unit 11 displays a selection tool for selecting a plurality of graph elements GE to be included in the same area AR. In response to selection based on a selection tool BX, the area setting unit 11 displays a window for setting the capacity of the area AR. Examples of the selection tool include a range selection tool such as a rectangle or a lasso (a figure drawn freehand) displayed on a mouse, a touch panel, or the like and an individual selection tool for individually selecting a graph element GE to be selected by clicking (touching).

The user disposes the virtual robot VM at a node ND (the shunting position SP or the closing position CP) corresponding to a current open/closed state of the door DR. When all the settings have been made, the area setting unit 11 converts the settings into a picture of the door DR. The area setting unit 11 replaces a current position of the virtual robot VM on the shunting line SL with a figure indicating an open state or a closed state of the door DR and displays the figure in the graph MP. Note that the example of FIG. 22 is an example of a double door DD, but a similar method is used in a case where an elevator EL is added to a graph MP.

### 6. Example of Application of Pathfinding Method in Present Disclosure

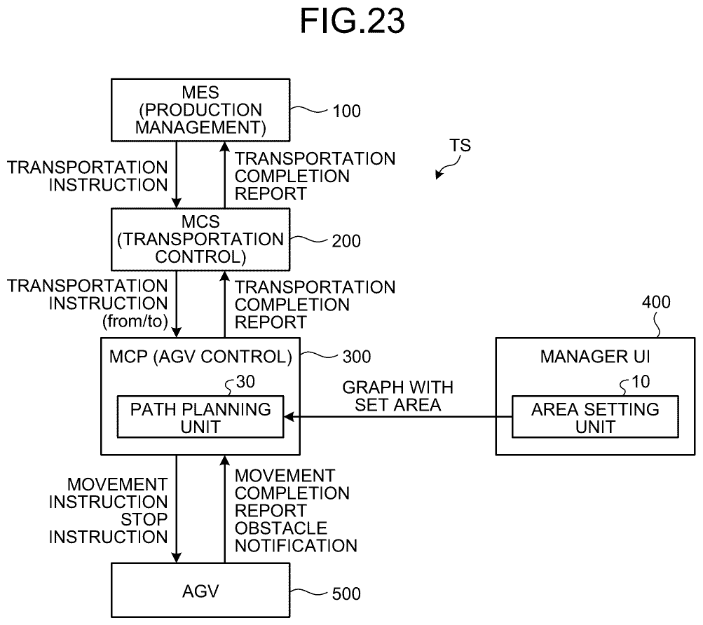

FIG. 23 is a diagram illustrating an example where the pathfinding method in the present disclosure is applied to an automatic transportation system in a factory based on an automated guided vehicle (AGV).

The transportation system TS includes a production management system (MES) 100, a transportation control system (MCS) 200, an AGV control system (MCP) 300, and AGVs 500. The MES 100 issues a transportation instruction to the MCS 200 on the basis of a manufacturing process. The transportation instruction here is, for example, “transport C from apparatus A to apparatus B”. On the basis of the received transportation instruction, the MCS 200 determines which AGV 500 is to be used to transport how and then issues a transportation instruction to the MCP 300. The transportation instruction here is, for example, “the AGV (determined as transportation means), transport C from point A to point B”.

Upon receiving the transportation instruction, the MCP 300 determines a specific movement path of the AGV 500. The path planning system in the present disclosure, which considers settings of doors DR, is used here. In addition, a manager of the system can add, change, and remove doors DR using a manager UI 400. When layout of the factory is changed, for example, the manager changes settings of the doors DR through the manager UI 400. The path planning unit 14 can perform path planning by reflecting the changed settings. In addition, the manager can refer to the settings of the doors DR made on the UI.

### 7. Example of Hardware Configuration

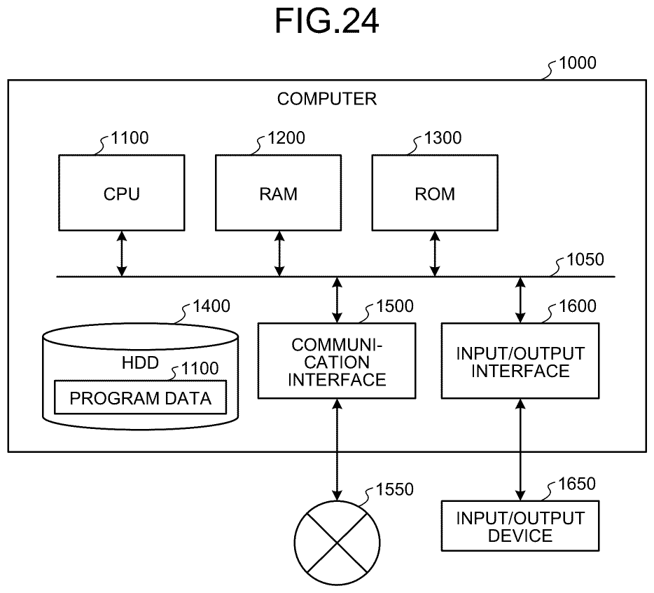

FIG. 24 is a diagram illustrating an example of a hardware configuration of the server 1. For example, the server 1 is achieved by a computer 1000. The computer 1000 includes a CPU 1100, a RAM 1200, a read-only memory (ROM) 1300, a hard disk drive (HDD) 1400, a communication interface 1500, and an input/output interface 1600. The components of the computer 1000 are connected to one another by a bus 1050.

The CPU 1100 operates on the basis of programs stored in the ROM 1300 or the HDD 1400 and controls the other components. For example, the CPU 1100 loads the programs stored in the ROM 1300 or the HDD 1400 into the RAM 1200 and performs processing corresponding to the various programs.

The ROM 1300 stores a boot program such as a basic input output system (BIOS) executed by the CPU 1100 when the computer 1000 is activated, programs that depend on hardware of the computer 1000, and the like.

The HDD 1400 is a computer-readable storage medium that stores programs to be executed by the CPU 1100, data (includes various databases) to be used by the programs, and the like in a non-transitory manner. More specifically, the HDD 1400 is a storage medium storing an information processing program according to the present disclosure as an example of program data 1450.

The communication interface 1500 is an interface for the computer 1000 to connect to an external network 1550 (e.g., the Internet). For example, the CPU 1100 receives data from other devices and transmits data generated by the CPU 1100 to other devices through the communication interface 1500.

The input/output interface 1600 is an interface for connecting an input/output device 1650 and the computer 1000 to each other. For example, the CPU 1100 receives data from an input device such as a keyboard or a mouse through the input/output interface 1600. In addition, the CPU 1100 transmits data to an output device such as a display, a speaker, or a printer through the input/output interface 1600. In addition, the input/output interface 1600 may function as a media interface that reads a program or the like stored in a certain storage medium. The medium is, for example, an optical storage medium such as a digital versatile disc (DVD) or a phase change rewritable disk (PD), a magneto-optical storage medium such as a magneto-optical disk (MO), a tape medium, a magnetic storage medium, a semiconductor memory, or the like.

In a case where the computer 1000 functions as the server 1, for example, the CPU 1100 of the computer 1000 achieves the above-described various functions by executing a program loaded into the RAM 1200. In addition, the HDD 1400 stores a program for causing the computer to function as the server 1. Note that the CPU 1100 reads the program data 1450 from the HDD 1400 and executes the program data 1450, but in another example, these programs may be obtained from another apparatus over the external network 1550.

### 8. Effects

The server 1 includes the graph structure generation unit 12 and the path planning unit 14. The graph structure generation unit 12 generates a graph MP where doors DR on passages PA have been replaced by shunting lines SL of virtual robots VM. The path planning unit 14 plans paths RT of a robot MB and a virtual robot VM such that the robot MB does not conflict with the virtual robot VM at an intersection between a passage PA and a shunting line SL when passing through the passage PA. In the information processing method in the present disclosure, the processing performed by the server 1 is performed by the computer 1000. The program in the present disclosure causes the computer 1000 to perform the processing performed the server 1.

With this configuration, paths RT of real robots MB and virtual robots VM (doors DR) are optimized by regarding movement of the doors DR as movement of the virtual robots VM on virtual shunting lines SL. The constraints relating to opening/closing timing and opening/closing time of the doors DR can be expressed as timing and movement time (costs) with which the virtual robots VM move on the shunting lines SL. Optimal path planning considering opening and closing of the doors DR, therefore, is performed.

The graph structure generation unit 12 sets, as one area AR, a plurality of doors DR whose opening and closing depends on each other so that only one of the doors DR is in an open state at a time. The path planning unit 14 plans paths RT of a plurality of virtual robots VM corresponding to the plurality of doors DR such that the plurality of virtual robots VM does not conflict in the same area AR.

With this configuration, optimal path planning considering the dependency between the plurality of doors DR is performed.

The plurality of doors DR includes a pair of doors DR constituting a double door DD.

With this configuration, optimal path planning considering the constraints including the opening/closing timing of each door DR and the like is performed.

The path planning unit 14 calculates a cost of a path plan of one or more robots MB to be optimized on the basis of the number of steps until each robot MB reaches a goal and time taken to open or close each door DR existing in the graph MP.

With this configuration, optimal path planning considering the opening/closing time of the doors DR is performed.

The plurality of doors DR includes doors DR of an elevator EL installed on different floors.

With this configuration, optimal path planning considering the constraints including opening/closing timing of the door DR on each floor and the like is performed.

The path planning unit 14 calculates a cost of a path plan of one or more robots MB to be optimized on the basis of the number of steps until each robot MB reaches a goal, time taken to open or close each door DR existing in the graph MP, and time taken for a car of the elevator EL to reach a position of a door that is to be in an open state.

With this configuration, optimal path planning is performed in consideration of opening/closing time of doors DR and movement time of a car.

The server 1 includes the area setting unit 11. The area setting unit 11 presents a UI for visually making settings for the doors DR.

With this configuration, areas AR can be easily set.

The graph structure generation unit 12 incorporates virtual robots VM and shunting lines SL into a graph MP on the basis of information regarding doors DR input through the UI.

With this configuration, the information regarding the virtual robots VM and the shunting lines SL can be automatically incorporated on the basis of the information input through the UI.

The area setting unit 11 replaces a current position of the virtual robot VM on the shunting line SL with a figure indicating an open state or a closed state of the door DR and displays the figure in the graph MP.

With this configuration, movement of doors DR is expressed as pictures of the doors DR themselves instead of virtual robots VM. The movement of the doors DR, therefore, can be easily understood.

Note that the effects described in the present specification are merely examples and are not limited, and other effects may also be produced.

### [Supplementary Notes]

Note that the present technology can also employ the following configurations.

(1)

An information processing apparatus comprising:
a graph structure generation unit that generates a graph where a door on a passage has been replaced by a shunting line of a virtual mobile body; and
a path planning unit that plans paths of a mobile body and the virtual mobile body such that the mobile body does not conflict with the virtual mobile body at an intersection between the passage and the shunting line when passing through the passage.
   (2)

The information processing apparatus according to (1),
wherein the graph structure generation unit sets, as one area, a plurality of doors whose opening and closing depends on each other so that only one of the plurality of doors is in an open state at a time, and
the path planning unit plans paths of a plurality of virtual mobile bodies corresponding to the plurality of doors such that the plurality of virtual mobile bodies does not conflict in the same area.
   (3)

The information processing apparatus according to (2),
wherein the plurality of doors includes a pair of doors constituting a double door.
   (4)

The information processing apparatus according to (3),
wherein the path planning unit calculates a cost of a path plan of one or more mobile bodies to be optimized on a basis of a number of steps until each mobile body reaches a corresponding goal and time taken to open or close each door existing in the graph.
   (5)

The information processing apparatus according to (2),
wherein the plurality of doors includes doors of an elevator installed on different floors.
   (6)

The information processing apparatus according to (5),
wherein the path planning unit calculates a cost of a path plan of one or more mobile bodies to be optimized on a basis of a number of steps until each mobile body reaches a corresponding goal, time taken to open or close each door existing in the graph, and time taken for a car of the elevator to reach a position of a door that is to be in an open state.
   (7)

The information processing apparatus according to any one of (1) to (6), further comprising:
an area setting unit that presents a UI for visually making settings for the door.
   (8)

The information processing apparatus according to (7),
wherein the graph structure generation unit incorporates the virtual mobile body and the shunting line into the graph on a basis of information regarding the door input through the UI.
   (9)

The information processing apparatus according to (7) or (8),
wherein the area setting unit replaces a current position of the virtual mobile body on the shunting line with a figure indicating an open state or a closed state of the door and displays the figure on the graph.
   (10)

An information processing method executed by a computer, the method comprising:
generating a graph where a door on a passage has been replaced by a shunting line of a virtual mobile body; and
planning paths of a mobile body and the virtual mobile body such that the mobile body does not conflict with the virtual mobile body at an intersection between the passage and the shunting line when passing through the passage.
   (11)

A program causing a computer to achieve:
generating a graph where a door on a passage has been replaced by a shunting line of a virtual mobile body; and
planning paths of a mobile body and the virtual mobile body such that the mobile body does not conflict with the virtual mobile body at an intersection between the passage and the shunting line when passing through the passage.

### REFERENCE SIGNS LIST

1 SERVER (INFORMATION PROCESSING APPARATUS)
11 AREA SETTING UNIT
12 GRAPH STRUCTURE GENERATION UNIT
14 PATH PLANNING UNIT
AR AREA
DD DOUBLE DOOR
DR DOOR
EL ELEVATOR
MB ROBOT (MOBILE BODY)
MP GRAPH
PA PASSAGE
RT PATH
SL SHUNTING LINE
VM VIRTUAL ROBOT (VIRTUAL MOBILE BODY)

1. An information processing apparatus comprising:
a graph structure generation unit that generates a graph where a door on a passage has been replaced by a shunting line of a virtual mobile body; and
a path planning unit that plans paths of a mobile body and the virtual mobile body such that the mobile body does not conflict with the virtual mobile body at an intersection between the passage and the shunting line when passing through the passage.

2. The information processing apparatus according to claim 1,
wherein the graph structure generation unit sets, as one area, a plurality of doors whose opening and closing depends on each other so that only one of the plurality of doors is in an open state at a time, and
the path planning unit plans paths of a plurality of virtual mobile bodies corresponding to the plurality of doors such that the plurality of virtual mobile bodies does not conflict in the same area.

3. The information processing apparatus according to claim 2,
wherein the plurality of doors includes a pair of doors constituting a double door.

4. The information processing apparatus according to claim 3,
wherein the path planning unit calculates a cost of a path plan of one or more mobile bodies to be optimized on a basis of a number of steps until each mobile body reaches a corresponding goal and time taken to open or close each door existing in the graph.

5. The information processing apparatus according to claim 2,
wherein the plurality of doors includes doors of an elevator installed on different floors.

6. The information processing apparatus according to claim 5,
wherein the path planning unit calculates a cost of a path plan of one or more mobile bodies to be optimized on a basis of a number of steps until each mobile body reaches a corresponding goal, time taken to open or close each door existing in the graph, and time taken for a car of the elevator to reach a position of a door that is to be in an open state.

7. The information processing apparatus according to claim 1, further comprising:
an area setting unit that presents a UI for visually making settings for the door.

8. The information processing apparatus according to claim 7,
wherein the graph structure generation unit incorporates the virtual mobile body and the shunting line into the graph on a basis of information regarding the door input through the UI.

9. The information processing apparatus according to claim 7,
wherein the area setting unit replaces a current position of the virtual mobile body on the shunting line with a figure indicating an open state or a closed state of the door and displays the figure on the graph.

10. An information processing method executed by a computer, the method comprising:
generating a graph where a door on a passage has been replaced by a shunting line of a virtual mobile body; and
planning paths of a mobile body and the virtual mobile body such that the mobile body does not conflict with the virtual mobile body at an intersection between the passage and the shunting line when passing through the passage.

11. A program causing a computer to achieve:
generating a graph where a door on a passage has been replaced by a shunting line of a virtual mobile body; and
planning paths of a mobile body and the virtual mobile body such that the mobile body does not conflict with the virtual mobile body at an intersection between the passage and the shunting line when passing through the passage.
